(19) United States
(12) Patent Application Publication
(10) Pub. No.: US 2026/0021809 A1
(43) Pub. Date: Jan. 22, 2026

(54) LANE FOLLOWING WITH OBJECT DETECTION FOR AUTONOMOUS VEHICLES

(71) Applicant: Stack AV Co., Mount Pleasant, PA (US)

(72) Inventors: Jeremy Lawrence SEAROCK, Glenshaw, PA (US); Mark OLLIS, Pittsburgh, PA (US); Peter William RANDER, Mars, PA (US); Travis BUSHNELL, San Francisco, CA (US)

(73) Assignee: Stack AV Co., Mount Pleasant, PA (US)

(21) Appl. No.: 18/774,543

(22) Filed: Jul. 16, 2024

(51) Int. Cl. B60W 30/165; B60W 10/18; B60W 10/20; B60W 50/14; B60W 60/00

(52) U.S. Cl. CPC B60W 30/165; B60W 10/18; B60W 10/20; B60W 50/14; B60W 60/001

(57) ABSTRACT

An autonomous control system for a vehicle is provided. The control system comprises a first sensor to detect a left lane line and a right lane line of a traffic lane. The control system comprises a second sensor to detect an object located within or proximate to the traffic lane. The control system processes first image data captured by the first sensor to determine locations of the left lane line and the right lane line of the traffic lane. The system generates a first control signal based on the determined locations of the left lane line and the right lane line, wherein the first control signal causes the vehicle to follow a vehicle trajectory between the left lane line and the right lane line. The control system further processes second data captured by the second sensor to determine an object location and compute an object trajectory.

### FIELD

The present disclosure relates generally to autonomous and semi-autonomous vehicles, and more specifically to control systems for lane following with object detection.

### BACKGROUND

Detection and avoidance of objects located in the blind spots of large vehicles, such as those towing a semi-trailer, often requires driver diligence and wide-angle rear-facing mirrors. Autonomous or semi-autonomous vehicles using sensor systems may detect objects in blind spots and produce a driver alert without altering the trajectory of the vehicle to avoid a collision.

### SUMMARY

As described above, avoiding an object on the road often requires drivers of large vehicles to observe the object or be alerted to its presence before responding themselves. Even large autonomous or semi-autonomous vehicles capable of maintaining a vehicle trajectory within a traffic lane may not have the ability to automatically adjust the vehicle trajectory upon detection of an object or another vehicle that may be encroaching on the traffic lane. Thus, known techniques may leave certain aspects of collision avoidance with respect to encroaching objects to human drivers, and therefore may be vulnerable to human error, reducing driver safety.

Accordingly, there is a need for improved lane following systems and methods for autonomous vehicles that enable detection of objects encroaching on a vehicle and/or the lane the vehicle is traveling in. Further, there is a need for a lane following system that can not only detect an encroaching object but can respond to such detection by altering the trajectory of the vehicle, thereby reducing the risk of collision between the object and the vehicle. Further, there is a need for a lane following system that can make adjustments to the lane position of an autonomous vehicle without departing from the lane that the autonomous vehicle is following, in response to the presence of a detected object near to or encroaching into the vehicle's travel lane; in this way, such a system is enabled to provide additional berth to detected objects without necessarily departing from the autonomous vehicle's travel lane or travel envelope. Described herein are systems and methods that may address one or more of the above-identified needs, including by controlling an autonomous vehicle based on computed vehicle and object trajectories.

As explained herein, in some embodiments, an autonomous control system of a vehicle may be used to control a vehicle to reduce the likelihood of collision with a detected object based on sensor input. The system may comprise a first sensor that is configured to detect the lane lines of the traffic lane the vehicle is traveling in, for example a forward-facing optical sensor. The system may also comprise a second sensor configured to detect an object that may be near to, or approaching, the lane line the vehicle is traveling in. The second sensor may take the form of, for example, one or more wide-angle sensors (e.g., cameras, LiDAR, radar, and/or sonar systems) that may be mounted to a vehicle's side mirrors and used to detect position, velocity, and acceleration of any object, including nearby vehicles. According to one or more embodiments, the second sensor may be mounted at any location on a vehicle that allows detection of objects located next to, in front of, or behind the vehicle.

As explained in further detail below, the system may use the first sensor (e.g., front-facing) to detect lane line positions, and may use the second sensor (e.g., side-facing wide-angle) to detect one or more other objects on the road in the proximity of the autonomous vehicle. Using the side-facing cameras, an object in the autonomous vehicle's blind spot may thus be detected. The system may determine a position and/or trajectory of the detected object. The system may then determine whether the position and/or trajectory of the detected object triggers one or more criteria based on position, proximity, and/or trajectory with respect to the autonomous vehicle, the detected lane lines, and/or the autonomous vehicle's planned trajectory. If the one or more criteria are triggered, for example by a predicted trajectory of the object encroaching too closely to the autonomous vehicle or within the travel lane of the autonomous vehicle in the autonomous vehicle's blind spot, then the system may automatically update the autonomous vehicle's planned trajectory in order to give a wider berth and/or avoid a predicted collision. In some embodiments, updating the autonomous vehicle's planned trajectory includes updating a travel position within the vehicle's travel lane without departing from the travel lane, thereby giving a wider berth to an object in the autonomous vehicle's blind spot and reducing collision risk (and, in some embodiments, increasing visibility of the object for a human driver of the autonomous vehicle).

In some embodiments, based on image data from the first sensor, the control system may determine the locations of the left lane line and right lane line that form the traffic lane the vehicle is traveling in, thereby allowing the system to compute a vehicle trajectory passing between the left lane line and right lane line. In some embodiments, computation of the vehicle trajectory may involve computation of a tolerance zone defined by the trajectory and extending from one or both sides of the trajectory, with the vehicle constrained to remain within the tolerance zone as it travels within the travel lane. The system may then generate a control signal causing the vehicle to follow the computed vehicle trajectory.

Based on data from the second sensor that indicates the presence of an object, e.g., another vehicle, proximate to the vehicle, the system may process the data to determine the location of the object and compute an object trajectory. In some embodiments, a confidence metric may be attached to the determination of the object trajectory. The control system may base the decision of how to respond to the object on the value of the confidence metric. For example, if the confidence metric meets a confidence threshold, the system may choose to respond to the object. However, if the confidence metric fails to meet the confidence threshold, the system may, for example, delay response to the object until the confidence metric increases. In addition, the system may alter the vehicle trajectory by an amount that is based on the confidence metric. For example, the system may alter the vehicle trajectory by a greater or by a lesser amount depending on whether the confidence metric meets the confidence threshold.

Once an object trajectory has been calculated, the system may compute the distance from the vehicle to the object and determine whether the object or the object's trajectory is proximate to either lane line of the traffic lane the vehicle is traveling in. If the object is sufficiently close and/or if there is such a predicted proximity of the object trajectory with a lane line, the tolerance zone, the subject vehicle itself, and/or a predicted trajectory of the subject vehicle itself, the system may then generate a second control signal causing the vehicle to modify the vehicle trajectory and/or the velocity of the vehicle. In some embodiments, this modification may result in an increase in distance between the vehicle and the object while maintaining the vehicle's trajectory between the two lane lines. Such an increase in distance may, for example, delay an intersection between the object trajectory and vehicle trajectory. The above process may repeat iteratively with the system generating first control signals causing the vehicle to follow a trajectory within the traffic lane and second control signals causing the vehicle to modify said trajectory to minimize the likelihood of a collision with one or more nearby objects. Modification of the vehicle's trajectory may avoid predicted collisions, minimize likelihood of possible collisions, give wider berth to detected objects, and/or increase the visibility of detected objects to a human driver of the autonomous vehicle by changing the relative position of the autonomous vehicle and the detected object.

In some embodiments, an autonomous control system of a vehicle is provided, the autonomous control system comprising: a first sensor to detect a left lane line and a right lane line of a traffic lane when the vehicle is traveling along the traffic lane; a second sensor to detect an object located within or proximate to the traffic lane; and one or more computer-readable media storing instructions that, when executed by one or more processors, cause the system to: process first image data captured by the first sensor to determine locations of the left lane line and the right lane line of the traffic lane; generate a first control signal based on the determined locations of the left lane line and the right lane line, wherein the first control signal causes the vehicle to follow a vehicle trajectory between the left lane line and the right lane line; process second data captured by the second sensor to determine an object location and compute an object trajectory; and generate a second control signal based on at least one of the object location and the object trajectory, wherein the second control signal causes the vehicle to modify at least one of the vehicle trajectory or a vehicle velocity.

In some embodiments, following the vehicle trajectory between the left lane line and the right lane line comprises controlling one or more vehicle control systems selected from the following: a steering control system, an acceleration control system, and a braking control system. In some embodiments, modifying the vehicle velocity comprises controlling one or more vehicle control systems selected from the following: a steering control system, an acceleration control system, and a braking control system. In some embodiments, modifying the vehicle trajectory comprises controlling one or more vehicle control systems selected from the following: a steering control system, an acceleration control system, and a braking control system. In some embodiments, the instructions cause the system to compute a tolerance zone extending from one or both sides of the vehicle trajectory. In some embodiments, the width of the tolerance zone is less than or equal to the width between the left lane line and the right lane line. In some embodiments, following the vehicle trajectory comprises remaining within the tolerance zone extending from the vehicle trajectory. In some embodiments, computing the object trajectory comprises computing a confidence metric associated with the object trajectory. In some embodiments, generation of the second control signal is based on determining the confidence metric associated with the object trajectory meets a confidence threshold. In some embodiments, generation of the second control signal is based on a proximity between the object trajectory and at least one of the left lane line or the right lane line. In some embodiments, generation of the second control signal is based on a proximity between the object and at least one of the left lane line or the right lane line. In some embodiments, generation of the second control signal is based on a proximity between the object trajectory and the tolerance zone. In some embodiments, generation of the second control signal is based on a proximity between the object and the tolerance zone. In some embodiments, generation of the second control signal is based on a proximity between the object trajectory and at least one of the vehicle or the vehicle trajectory. In some embodiments, generation of the second control signal is based on a proximity between the object and at least one of the vehicle or the vehicle trajectory. In some embodiments, generation of the second control signal is based on determining that a computed distance between the vehicle and the object is less than a distance threshold. In some embodiments, generation of the second control signal is based on a proximity between the object and a blind-spot region located adjacent to the vehicle. In some embodiments, modifying at least one of the vehicle velocity or the vehicle trajectory comprises: increasing a distance between the vehicle and the object; and maintaining the vehicle trajectory between the left lane line and the right lane line. In some embodiments, the instructions cause the system to increase the distance by an amount that delays an intersection between the object trajectory and the vehicle trajectory. In some embodiments, the instructions cause the system to generate at least one of an audible driver alert or a visual driver alert. In some embodiments, computing the object trajectory comprises tracking the object as it passes from a field of view of the first sensor to a field of view of the second sensor. In some embodiments, computing the object trajectory comprises tracking the object as it passes from a field of view of the second sensor to a field of view of the first sensor. In some embodiments, the vehicle is a first vehicle and the object is a second vehicle. In some embodiments, the second sensor is an optical sensor. In some embodiments, the second sensor is a LiDAR sensor. In some embodiments, the second sensor is a radar sensor. In some embodiments, the second sensor is a sonar sensor.

In some embodiments, a method for autonomously controlling a vehicle is provided, the method comprising: processing first image data captured by a first sensor to determine locations of a left lane line and a right lane line of a traffic lane; generating a first control signal based on the determined locations of the left lane line and the right lane line, wherein the first control signal causes the vehicle to follow a vehicle trajectory between the left lane line and the right lane line; processing second data captured by a second sensor to determine an object location and compute an object trajectory; and generating a second control signal based on at least one of the object location and the object trajectory, wherein the second control signal causes the vehicle to modify at least one of the vehicle trajectory or a vehicle velocity.

In some embodiments, a non-transitory computer readable storage medium storing instructions for autonomously controlling a vehicle is provided, wherein the instructions, when executed by one or more processors of an electronic device, cause the device to: process first image data captured by a first sensor to determine locations of a left lane line and a right lane line of a traffic lane; generate a first control signal based on the determined locations of the left lane line and the right lane line, wherein the first control signal causes a vehicle to follow a vehicle trajectory between the left lane line and the right lane line; process second data captured by a second sensor to determine an object location and compute an object trajectory; and generate a second control signal based on at least one of the object location and the object trajectory, wherein the second control signal causes the vehicle to modify at least one of the vehicle trajectory or a vehicle velocity.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary scenario involving a vehicle encroaching on the lane of a vehicle outfitted with an autonomous control system, according to some embodiments.

FIG. 1B depicts an exemplary system for a vehicle enabling lane following and object detection, according to some embodiments.

FIG. 2 depicts an exemplary process utilizing an autonomous control system to detect and respond to nearby objects, according to some embodiments.

FIG. 3A depicts an exemplary situation involving a vehicle encroaching on the lane of a vehicle outfitted with an autonomous control system, according to some embodiments.

FIG. 3B depicts an exemplary situation involving the modification of the vehicle trajectory to delay an intersection between the vehicle trajectory and object trajectory, according to some embodiments.

FIG. 4 depicts an exemplary process involving computation of a tolerance zone extending from the vehicle trajectory, according to some embodiments.

FIG. 5 depicts an exemplary vehicle outfitted with an autonomous control system within a tolerance zone extending from a vehicle trajectory, according to some embodiments.

FIG. 6 illustrates an exemplary computing system, according to some embodiments.

### DETAILED DESCRIPTION

As described, a vehicle's detection and avoidance of an object on the road requires awareness of the presence and trajectory of the object. Known techniques for object avoidance may rely entirely or primarily on the diligence of the driver or may provide an alert without modifying the vehicle trajectory. Furthermore, known techniques may not automatically adjust vehicle position and trajectory within a travel lane to proactively reduce collision risk based on the detection of proximate objects.

Accordingly, disclosed herein are systems and methods for autonomous vehicles to detect a proximate and/or encroaching object and modify the vehicle trajectory to reduce the likelihood of a collision. The system may comprise a first sensor to detect the lane lines of the traffic lane the vehicle is traveling in and a second sensor configured to detect an object that is nearby to the vehicle (for example, located in a blind spot of the vehicle). Image data from the first sensor may be used to determine the lane line positions that are in turn used to compute the vehicle trajectory and produce a control signal causing the vehicle to follow the computed trajectory. In this manner, the systems and methods disclosed herein enable the vehicle to follow the traffic lane. Data from the second sensor indicating the presence of an object may be used to determine the location of a nearby object and compute its trajectory. According to some embodiments, if the object or the object trajectory is sufficiently proximate to one or more of the lane lines of the traffic lane the vehicle is traveling in, a tolerance zone extending from the vehicle trajectory, and/or the vehicle itself or the vehicle trajectory, the system may generate a control signal causing the vehicle to increase its distance from the object while remaining within the traffic lane, thereby potentially delaying or avoiding a collision with the object.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMS, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

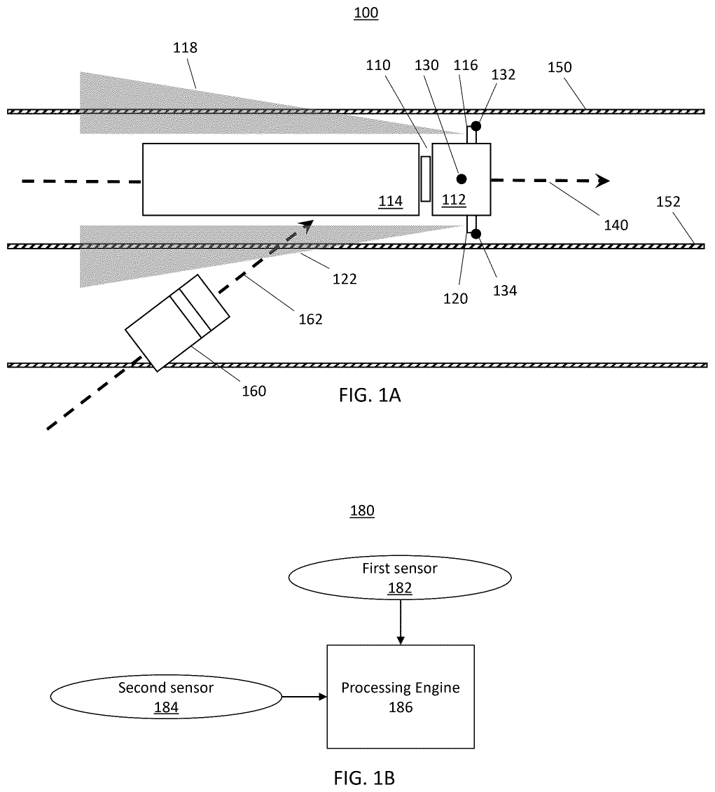

FIG. 1A depicts exemplary scenario 100 involving a vehicle encroaching on the lane of a vehicle outfitted with an autonomous control system. Exemplary vehicle 110 is depicted as a tractor 112 towing a semi-trailer 114, and is traveling in a traffic lane defined by left lane line 150 and a right lane line 152. The vehicle is traveling within the traffic lane along trajectory 140. Vehicle 110 may include one or more side mirrors, for example left side mirror 116 and right side mirror 120, associated with left mirror field of view 118 and right mirror field of view 122. While use of wide-angle mirrors may extend the field of view for the mirrors, each mirror field of view may inherently be limited and may include blind spots, e.g., zones outside of the mirror field of view that are not visible to the driver either through the side mirrors or otherwise.

In a dynamic environment such as a roadway, objects including other vehicles may quickly change position and trajectory and, for example, if they are located outside a driver's field of view, they may give the driver little time to react to minimize the likelihood of a collision between the object and the driver's vehicle. For example, if a separate vehicle 160 approaches vehicle 110 along trajectory 162, vehicle 160 is outside of right mirror field of view 122 at the moment shown in exemplary scenario 100. Thus, separate vehicle 160 may not be visible to the driver of vehicle 110 at the moment shown in exemplary scenario 100. If vehicle 160 continues on trajectory 162 as shown without steering away, the driver of vehicle 110 may have little time to modify trajectory 140 to avert a collision between the two vehicles.

Use of an autonomous control system depicted in FIG. 1B for lane following and object detection, and use of associated methods described herein, may avoid or alleviate a negative outcome in the above scenario. Autonomous control system 180 may comprise first sensor 182. As shown in exemplary scenario 100 of FIG. 1A, first sensor 182 may comprise a forward-facing optical sensor such as sensor 130. Sensor 130 may continuously detect, for example, left lane line 150 and right lane line 152, and may thereby provide system 180 data sufficient to calculate a trajectory between the two lane lines and optionally generate a control signal that causes the vehicle to following the trajectory. For example, by detecting the positions of left lane line 150 and right lane line 152 using sensor 130, system 180 may compute a vehicle trajectory that maintains vehicle 110 within both lane lines and that corresponds to trajectory 140.

Autonomous control system 180 may also comprise second sensor 184. According to some embodiments, second sensor 184 may be an optical sensor and may include a “fisheye” lens, and/or may have a field of view greater than 90 degrees and potentially greater than 270 degrees. According to some embodiments, second sensor 184 may additionally or alternatively use LiDAR, radar, and/or sonar detection. As shown in exemplary scenario 100 of FIG. 1A, second sensor 184 may comprise a laterally facing wide-angle sensor, depicted as sensor 132 and/or sensor 134 mounted to left side mirror 116 and/or right side mirror 120 respectively. As an example, sensors 132 and 134 may be monocular optical sensors with each having a field of view of 180 degrees giving the system a front, side, and rear view from both sides of vehicle 110.

Returning to the above-described scenario involving vehicle 160 encroaching on the traffic lane of vehicle 110, if sensors 132 and 134 were installed on vehicle 110, they would potentially detect vehicle 160 early in its approach along trajectory 162 toward vehicle 110. While approaching, as mentioned above, vehicle 160 would have been outside of field of view of the right mirror 122 and potentially not visible to the driver of vehicle 110. By adding sensors 132 and 134 with wide fields of view to the side mirrors of vehicle 110, an object such as vehicle 160 could be detected by, for example, sensor 134. This sensor in turn could provide system 180 with data indicating the presence of an approaching object and sufficient to calculate the location and trajectory of the object. Were the location or trajectory determined to be proximate to one or more lane lines forming the traffic lane vehicle 110 is traveling in and/or to vehicle 110 itself or vehicle trajectory 140, as disclosed herein, system 180 could generate a control signal to modify trajectory 140 to delay or avoid an intersection between the trajectories of the two vehicles or to avoid a collision altogether.

While FIGS. 1A and 1B depict a limited number of sensors, system 180 may potentially comprise three or more sensors. To account for redundancies and improve handling of data inputs from multiple sensors, system 180 may build a continuous model of the vehicle's surroundings based on inputs from one or more of the sensors. With such a continuous model, the system may track a nearby object as it passes from the field of view of one sensor and into the field of view of the next. Such a multiple-sensor approach, and associated data handling processes, may extend the field of view of system 180 and improve object detection in challenging conditions that may occur when a vehicle is traveling on a roadway crowded with other motorists or when atmospheric conditions such as fog are present.

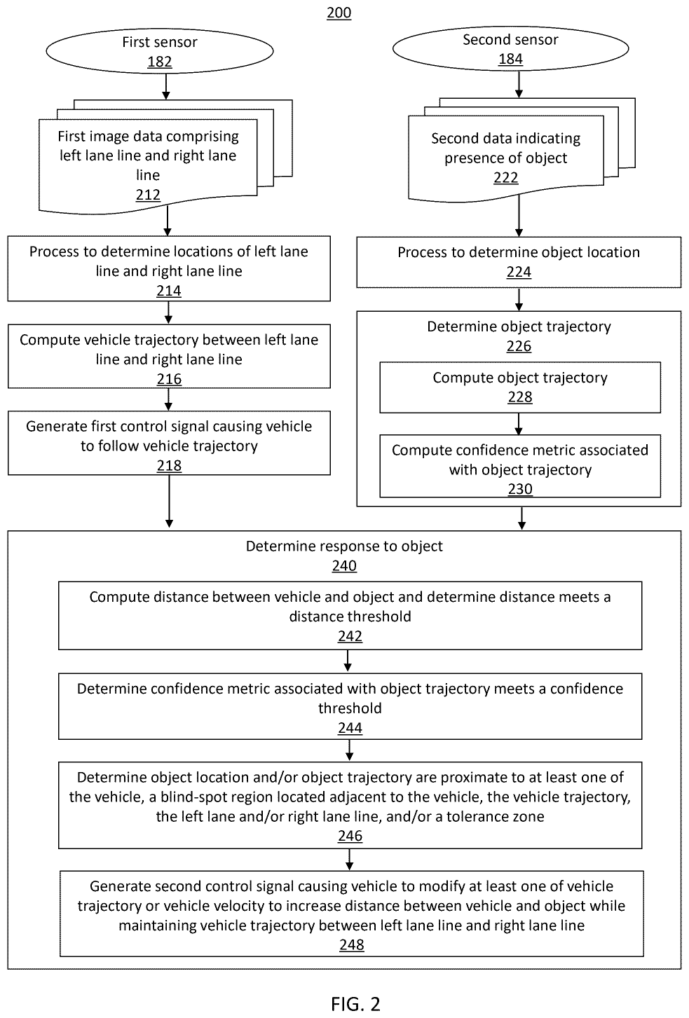

FIG. 2 depicts exemplary process 200 that utilizes control system 180 to maintain the trajectory of the vehicle while responding to a detected object. First sensor 182 may optionally comprise a roof-mounted forward-facing optical camera. The sensor may have a field of view of 50 degrees or more and may be capable of detecting one or more lane lines defining the traffic lane the vehicle is traveling in. Data 212 from first sensor 182 may comprise image data including the left lane line and right lane line.

In process 200, system 180 may process this data to determine the locations of the left lane line and right lane line at step 214. Lane line locations within the field of view of sensor 182 may be determined, and lane line locations outside the field of view of sensor 182 (e.g., lane line locations far ahead of the vehicle, beside the vehicle, or behind the vehicle) may be predicted or estimated based on the lane line portions that are visible to sensor 182. At step 216, the system may then compute a vehicle trajectory based on the vehicle's position relative to the locations of the left lane line and right lane line as determined based on data 212. In one or more examples, this vehicle trajectory may be located at or near a center-line between the left lane line and right lane line. In some embodiments, the vehicle trajectory may be offset from the center-line, closer to the left lane line or to the right lane line, for example based on road conditions detected by system 180. According to some embodiments, while the vehicle is following the lane, the vehicle trajectory will remain between the left lane line and right lane line.

Next, at step 218, system 180 may generate a first control signal that causes the vehicle to follow the computed vehicle trajectory. In one or more examples, the vehicle may follow the trajectory by controlling one or more vehicle control systems selected from the following: a steering control system, an acceleration control system, and a braking control system. For example, the control signal may cause the vehicle to control the steering control system, turning the vehicle to ensure it follows the trajectory.

Second sensor 184 may optionally comprise laterally facing, side mirror-mounted sensors using one or more of the following modes of detection: optical, LiDAR, radar, and/or sonar. In one or more examples, sensor 184 may comprise two wide-angle sensors giving system 180 rear, side, and front information from both sides of the vehicle, for example sensors 132 and 134 in FIG. 1. As discussed, an exemplary field of view for sensor 184 would provide system 180 with information about objects located in the blind-spot region that is not visible to the driver via use of the side mirrors. Thus, second sensor 184 may be particularly useful for detecting objects, such as other vehicles, that pose a potential collision risk to vehicle 110.

In exemplary process 200, second sensor 184 may produce second data 222 that may include an indication that an object is present in the vicinity of the vehicle. This second data may comprise a stream of frames of LiDAR point cloud data, optical video data, or data from a radar or sonar sensor. This data may then be used as an input for step 224 wherein the location of the object is determined by system 180. In one or more examples, system 180 may evaluate the distance of the object from the sensor to determine if it is less than a distance threshold and is thus considered sufficiently proximate to the vehicle to respond to. According to one or more embodiments, the distance threshold may be based on the size of the vehicle and/or a trailer attached to the vehicle, as well as the size of objects previously detected by system 180. For example, the distance threshold may be set to ensure a response to an object located a distance from the vehicle equal to less than the width of the vehicle.

Alternatively, if for example the distance is greater than the distance threshold, the system may delay a response until the object's distance from the vehicle falls below the distance threshold. Further, if the object's location cannot be accurately measured, for example due to obstruction by another vehicle or environmental noise, system 180 may similarly choose to delay response until the location measurement can accurately be made. In this respect, a confidence metric may optionally be attached to the location measurement, wherein the system modifies its response to the object based on whether the confidence metric meets a specified confidence threshold. For example, the system may decide whether or not to respond to a detected object, or may modify the amount by which it responds, based on the confidence metric. According to some embodiments, the system may optionally increase the amount by which it modifies the vehicle trajectory, or may optionally decrease the amount, based on a confidence metric that fails to meet the confidence threshold.

Once the object's location has been determined, system 180 may determine the object's trajectory at step 226, involving first computing an object trajectory at substep 228 and determining a confidence metric to associate with object trajectory at substep 230. Given the inherent uncertainty in predicting the future path of an object, system 180 may base any object trajectory computations both on an object's past motion and the present object location. For example, if the detected object is another vehicle, system 180 may use as an input to the computation of the vehicle's trajectory the past motion of the vehicle including whether the vehicle's driver followed bends in the traffic lane he or she was driving in or whether instead the driver tended to drive in a straight line, crossing one or more of the lane lines before returning to the vehicle's traffic lane.

According to some embodiments, computing object trajectory at step 228 may involve use of machine learning. By optionally training system 180's object trajectory computation on large sets of data from sensors monitoring the motion of vehicles and other road objects (e.g., a wind-blown traffic barrier or cone, a detached piece of debris previously on a nearby vehicle, etc.) the fidelity of the trajectory computation may be increased such that the computation may predict future object motion and driver behavior based on observations made in the immediate past. Sources of such sets of data may comprise, for example, publicly available datasets such as the COCO (Common Objects In Context) dataset, datasets created by gathering and labeling data from one or more sensors of system 180, and/or a combination thereof.

A confidence metric may be attached to the computed trajectory. Such a metric may be based in part on machine learning training, e.g., based on the similar motion of many other objects or vehicles, and represent the degree of certainty that such a trajectory may be relied upon for further object response process steps.

In one or more examples, once an object location and trajectory have been calculated, system 180 may next determine a response to the object at step 240. The system may assess the object's location, the distance of the object from the sensor, and the object trajectory to determine whether the object and/or the object trajectory are at risk of intersecting with, or coming proximate to, various points or regions associated with the vehicle. These may include the vehicle itself, the blind-spot region located adjacent to the vehicle, the vehicle trajectory, the left lane and/or right lane line, and/or the tolerance zone defined with respect to the vehicle trajectory.

Optionally, at substep 242, responding to the detected object may involve first computing the distance from the vehicle to the object and determining that the distance is less than a distance threshold. As discussed, system 180 computes the distance to the object to check whether it is sufficiently close to respond to. By placing an upper limit or threshold on object distance, the responsivity of the system is restrained to ensure the system produces a response only for objects that may pose a collision risk for the vehicle, and not those that are too far to pose a threat in the immediate future. This is especially important on a crowded roadway with many other vehicles, some potentially far from the vehicle and unlikely or unable to collide with it.

Next, at substep 244, system 180 may determine that the confidence metric associated with the object trajectory exceeds a confidence threshold. As discussed, given inherent uncertainties in the computation of an object's future trajectory, system 180 may have low confidence an object will follow a computed trajectory. A confidence threshold may be assigned to the confidence metric such that, for example, objects with computed trajectory confidence metrics falling below the threshold may not produce a further response from the system unless and until the confidence metric increases above the confidence threshold. In some embodiments, objects with computed trajectory confidence metrics equal to or greater than the threshold may produce a further response from the system. In one or more examples, system 180 may increase the distance between the vehicle and the object in response to a confidence metric that falls below the confidence threshold. According to some embodiments, instead of applying a confidence threshold which in effect treats the confidence metric as a binary value, system 180 may modulate response to the object trajectory based on the confidence metric as discussed below. Additional variables upon which the confidence metric may be based include, for example, the duration an object has been observed with higher durations increasing the likelihood the detection is not a false positive, the length of time since the object was last detected with more recent detections increasing the likelihood the object remains proximate to the vehicle, and/or variables corresponding to detection strength such as the number of pixels or intensity of reflected radar signals corresponding to the object.

Following this optional determination with respect to the confidence metric of the object trajectory, system 180 may next determine at substep 246 whether the object or the object trajectory is proximate to, or within a distance threshold of, one or more of the following: the left lane line and/or the right lane line of the traffic lane that vehicle 110 is traveling in, the vehicle itself or the vehicle trajectory, a blind-spot region adjacent to the vehicle, and/or the tolerance zone defined with respect to the vehicle trajectory. For example, if an object or vehicle in a neighboring lane has repeatedly crossed the right lane line of the traffic lane that vehicle 110 is traveling in and its motion indicates it may do so again, an object trajectory may be computed that intersects the right lane line. A similar situation is shown in FIG. 1A, wherein the computed object trajectory 162 of vehicle 160 places it on track to violate right lane line 152 and collide with vehicle 110 in the near future, an event that may require a response from system 180 to reduce the likelihood of such an impact.

An object within the traffic lane in which vehicle 110 is traveling in may also pose a risk, even if the vehicle is in the line of sight of the driver, e.g. not located in a blind spot. For example, a slow-moving vehicle in front of vehicle 110 may pose a risk and safety may be increased by maintaining a wide berth relative to such an object. In such a case, system 180 may generate a second control signal causing the vehicle to modify vehicle trajectory and/or vehicle velocity, just as it would in responding to object trajectories that intersect the left lane line or the right lane line.

Based on a determination that the object or the object trajectory is proximate to the left lane line and/or the right lane line, the vehicle or the vehicle trajectory, a blind-spot region, and/or the tolerance zone, system 180 may, for example, generate a second control signal at substep 248. Generating such a control signal may cause the vehicle to modify, for example, at least vehicle trajectory and/or vehicle velocity for the purpose of maintaining or increasing the distance between the object and the vehicle.

In one or more examples, the vehicle may modify vehicle trajectory and/or vehicle velocity by controlling one or more vehicle control systems selected from the following: a steering control system, an acceleration control system, and a braking control system. To modify vehicle trajectory, the second control signal may optionally cause the vehicle to control the steering control system, for example by turning the vehicle away from an encroaching object. For example, returning to FIG. 1A, if vehicle 110 controlled the steering control system by turning the vehicle to the left, the distance between vehicle 110 and encroaching vehicle 160 would increase, potentially increasing the time until collision between the two vehicles. Such an increase in distance would potentially give the driver of encroaching vehicle 160 additional time to adjust their trajectory or velocity thereby potentially reducing the energy dissipated and damage done by the collision.

Alternatively, to modify vehicle velocity, the second control signal may optionally cause the vehicle to control the acceleration control system and/or the braking control system, producing a corresponding increase or decrease in the vehicle's velocity. Such a modulation of vehicle velocity would potentially increase the distance between the vehicle and the object. Returning again to FIG. 1A, if vehicle 110 controlled the acceleration control system by increasing the velocity of vehicle 110, depending on the velocity and trajectory of encroaching vehicle 160, the distance between vehicle 110 and encroaching vehicle 160 may increase by allowing the encroaching vehicle to move behind vehicle 110. This increase in distance could potentially avoid a collision between the two vehicles or reduce the severity of a collision, e.g., with vehicle 160 hitting a rear corner of trailer 114 instead of producing a high energy collision with the right side of the trailer. Alternatively, if vehicle 110 controlled the braking control system by decreasing the velocity of vehicle 110, depending on the velocity and trajectory of the encroaching vehicle, the distance between the two vehicles may also be increased by allowing the encroaching vehicle to move ahead of vehicle 110. Such an increase could similarly avoid a collision or cause encroaching vehicle 160 to deflect off the front edge of tractor 112.

Thus, the second control signal may optionally take as inputs an object trajectory computed to intersect a lane line of a lane the vehicle is traveling in, and the vehicle's own trajectory in the lane and may cause the vehicle to modify the vehicle trajectory and/or the vehicle velocity in a manner that may increase the distance between the object and the vehicle thereby potentially reducing the likelihood of a collision between the object and the vehicle. To prevent vehicle actions in response to an encroaching object from causing additional harm, the second control signal generated at step 248 may be configured to ensure the vehicle maintains its trajectory between the left lane line and right lane line. In the above hypothetical in which vehicle 110 depicted in FIG. 1A controlled the steering control system to turn vehicle 110 to the left and away from encroaching vehicle 160, vehicle 110 may only turn the vehicle to the degree that the vehicle does not cross left lane line 150 and that, following completion of the turn, vehicle trajectory 140 remains within left lane line 150 and right lane line 152.

In one or more examples, system 180, when generating the second control signal to modify the vehicle trajectory in response to an encroaching object, may use one or more approaches in determining the direction and the degree by which to modify the vehicle trajectory. In one example, system 180 may maximize the distance between the vehicle and the object while remaining within the confines of the traffic lane. In another example, system 180 may increase the distance between the object and the vehicle as a function of the confidence metric of the computed object trajectory. That is, the system may respond to a low confidence trajectory by adjusting distance between the vehicle and the object by a lower amount than it would had the confidence metric associated with the trajectory been higher. Alternatively, the system may respond to a low confidence trajectory by increasing the distance between the vehicle and the object by a higher amount than it would otherwise have had the confidence metric been higher. In another example, system 180 may adjust distance between the vehicle and the object as a function of the distance between the vehicle and the intersection between the object trajectory on one hand and the vehicle trajectory and/or one or more of the lane lines of the lane the vehicle is traveling in on the other hand. That is, if the intersection between the object trajectory on one hand and the vehicle trajectory and/or one or more of the lane lines on the other hand is projected to take place a considerable distance away, corresponding to a considerable amount of projected time, system 180 may adjust distance between the vehicle and the object by a low amount or delay adjusting distance entirely. Whereas, were the intersection to be closer, the system may adjust distance by a greater amount. In the case of an encroaching object in the form of another vehicle, such a delay or moderated adjustment may allow the other driver time to return to more closely following the lane they are driving in, thereby delaying or eliminating the intersection between their computed trajectory and the vehicle trajectory and/or one of the lane lines of the traffic lane vehicle 110 is driving in.

The second control signal thereby may be referred to as a “nudge,” causing the vehicle to take advantage of space within the traffic lane it is traveling in to increase the distance between the vehicle and the object while remaining within the bounds of the lane lines defining the traffic lane.

In addition to generating a second control signal, once system 180 optionally determines that a confidence metric associated with an object trajectory meets a confidence threshold and that the object or the object trajectory is proximate to the left lane line and/or the right lane line, the vehicle or the vehicle trajectory, a blind-spot region, and/or the tolerance zone, the system may generate one or more driver alerts. These alerts may comprise a visual alert, e.g., a blinking light or symbol on a screen, an audio alert, e.g., one or more loud beeping sounds, and/or a haptic alert. One or more such alert types may function to alert the driver, as soon as the system is confident in its computations, that an object collision risk exists. Such advance warning may allow the driver to take manual corrective action to avoid the collision, without or in addition to the system taking action by controlling one or more of the vehicle's control systems.

Exemplary process 200 may, for example, repeat iteratively such that data from the first and second sensor are continuously being processed and the first control signal being repeatedly generated to ensure the vehicle continues to follow the traffic lane, with the second control signal being repeatedly generated to ensure the distance between the vehicle and any detected object is increased, and thus the risk of a collision between the vehicle and object reduced, while maintaining the vehicle trajectory within the traffic lane.

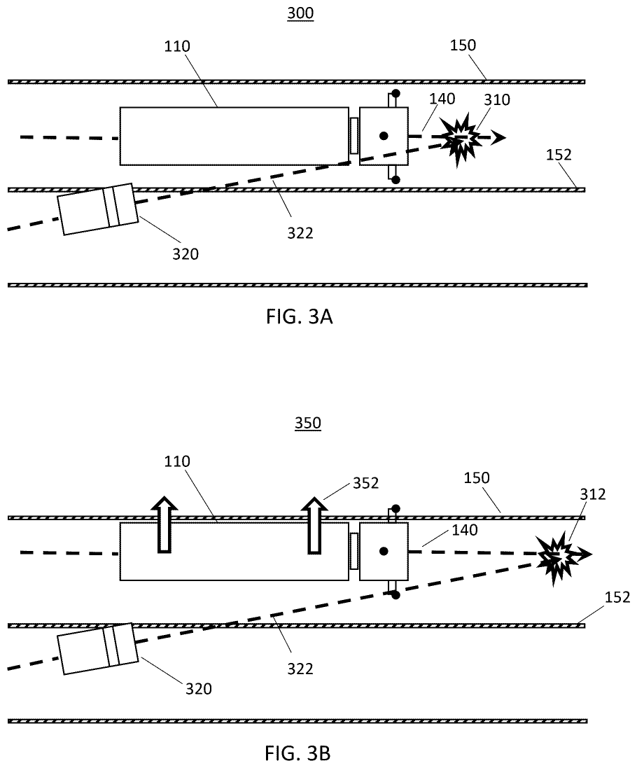

As shown in exemplary situation 300 in FIG. 3A, the computed object trajectory 322 of encroaching vehicle 320 intersects with right lane line 152. Furthermore, the object trajectory also intersects with the trajectory of vehicle 110 (e.g., trajectory 140) at point 310. The predicted collision, and its precise location and time, may be dependent upon the velocities and trajectories of encroaching vehicle 320 and vehicle 110. However, as mentioned above, an intersection between object trajectory 322 and right lane line 152 may be sufficient to cause system 180 to generate a second control signal causing the vehicle to modify vehicle trajectory and/or vehicle velocity to increase the distance between the vehicle and the object. As discussed, the direction and distance by which to modify vehicle position and trajectory may be determined based on several factors including trajectory of the encroaching object and the confidence metric associated with said trajectory.

In determining how to modify vehicle trajectory 140, system 180 may additionally weigh distance and/or time from vehicle 110 to the intersection between the vehicle trajectory 140 and the object trajectory 322. In situation 300 of FIG. 3A, before modification of vehicle trajectory by system 180, the two trajectories intersect at point 310. As shown in situation 350 of FIG. 3B, the second control signal of system 180 caused the vehicle to control the steering control system, thereby moving vehicle trajectory 140 to the left, away from encroaching vehicle 320. In so doing, system 180 may increase the distance between the two vehicles by an amount that delays an intersection between the two vehicles' trajectories: following vehicle 110's move, trajectory 140 and trajectory 322 intersect at point 312, a greater distance from vehicle 110 that thus represents a later point in time. According to some embodiments therefore, system 180, when generating the second control signal to modify the vehicle trajectory in response to an encroaching object, may cause the vehicle to modify the trajectory by a distance that delays an intersection between the vehicle trajectory and object trajectory.

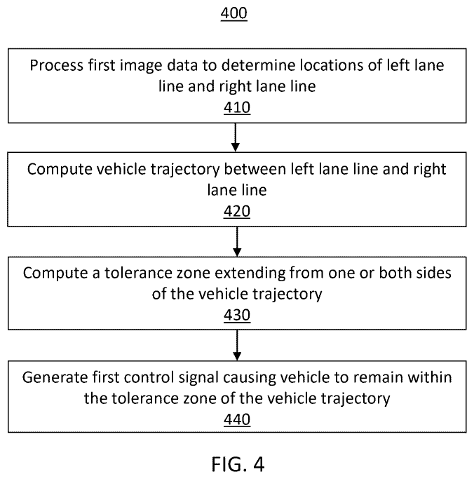

FIG. 4 depicts an exemplary process 400 to generate the first control signal. As described with respect to exemplary process 200, to enable the vehicle to follow the traffic lane it is traveling in, first image data 212 may be processed to determine the locations of the left lane line and right lane line at step 410 in FIG. 4. After processing first data, a vehicle trajectory between the left lane and right lane may be computed at step 420. To reduce the frequency with which adjustments to a trajectory must be made, a zone extending from one or both sides of the vehicle trajectory may be created, such that the vehicle is constrained to remain within the zone, which may be referred to as a tolerance zone as discussed above. The location and extent (e.g., width) of this tolerance zone may be computed at step 430. In some embodiments, system 180 may require the vehicle to simply remain within the bounds of a tolerance zone surrounding the trajectory, controlling one or more vehicle control systems to modify the direction of the vehicle as the vehicle approaches the bounds of the tolerance zone to ensure it remains within the zone.

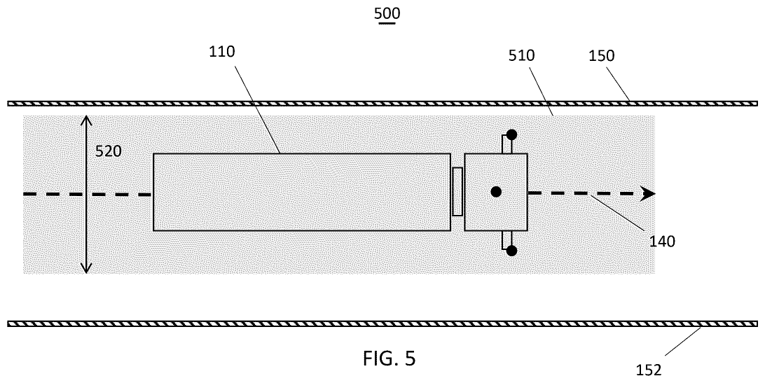

An exemplary tolerance zone 510 extending from both the left and right sides of vehicle trajectory 140 is depicted in exemplary situation 500 in FIG. 5. While the tolerance zone may be constrained to remain within the traffic lane, the width of the zone 520 may be less than or equal to the width between the left lane line and the right lane line, and the zone may or may not be centered between the two lane lines. A typical tolerance zone may optionally be defined by a fixed margin (for example, 8 inches) with respect to the left and/or right lane line depending, for example, on the condition or presence of adjacent lanes, and/or on the number of desired interventions by system 180, with the number of interventions required increasing with decreasing tolerance zone width. The tolerance zone may be adjusted to create a wider margin (for example, 15 centimeters) between the vehicle and objects with which it could collide (for example, traffic cones), and a narrower margin (for example, 8 centimeters) between the vehicle and painted line features (for example, left and right lane lines) that are possible for the vehicle to drive over without colliding.

For example, in situation 500, the vehicle trajectory 140 and surrounding tolerance zone 510 are offset to the left side of the lane. By defining a zone surrounding the vehicle trajectory for the vehicle to travel within that can shift both in location within the lane and width across the lane, system 180 reserves the ability to respond to changing road conditions. For example, if an adjacent lane is closed due to construction, with barriers placed close to the right lane line, it may be advantageous for the system to create a buffer zone between the vehicle and the barriers by offsetting the trajectory and tolerance zone to the left side of the lane and/or shifting the tolerance zone to the far left of the lane such that it is no longer centered on the vehicle trajectory. Similar to process 200, once the vehicle trajectory and associated tolerance zone have been computed, at step 440 of process 400 system 180 may generate a first control signal that causes the vehicle to remain within the tolerance zone of the vehicle trajectory. By placing a tolerance zone around the vehicle trajectory, in one or more examples, the frequency of trajectory adjustments made by system 180 may be reduced, a change that may reduce the complexity of the autonomous control system. Furthermore, the tolerance zone may impose an outer limit on which the autonomous vehicle may shift from one side to another while remaining within the travel lane, thereby allowing the vehicle lateral flexibility in its lane positioning such that it can be “nudged” from side to side to give berth to nearby and/or potentially encroaching objects, while still remaining safely within the travel lane.

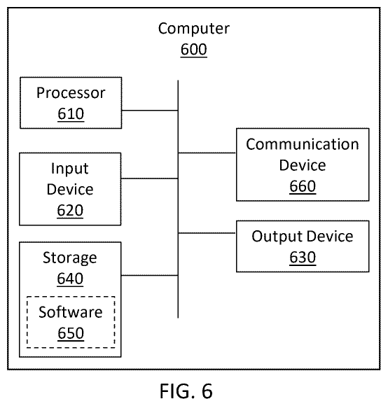

In one or more examples, the disclosed systems and methods utilize or may include a computer system. FIG. 6 illustrates an exemplary computing system according to one or more examples of the disclosure. Computer 600 can be a host computer connected to a network. Computer 600 can be a client computer or a server. As shown in FIG. 6, computer 600 can be any suitable type of microprocessor-based device, such as a personal computer, workstation, server, or handheld computing device, such as a phone or tablet. The computer can include, for example, one or more of processor 610, input device 620, output device 630, storage 640, and communication device 660. Input device 620 and output device 630 can correspond to those described above and can either be connectable or integrated with the computer.

Input device 620 can be any suitable device that provides input, such as a touch screen or monitor, keyboard, mouse, or voice-recognition device. Output device 630 can be any suitable device that provides an output, such as a touch screen, monitor, printer, disk drive, or speaker.

Storage 640 can be any suitable device that provides storage, such as an electrical, magnetic, or optical memory, including a random-access memory (RAM), cache, hard drive, CD-ROM drive, tape drive, or removable storage disk. Communication device 660 can include any suitable device capable of transmitting and receiving signals over a network, such as a network interface chip or card. The components of the computer can be connected in any suitable manner, such as via a physical bus or wirelessly. Storage 640 can be a non-transitory computer-readable storage medium comprising one or more programs, which, when executed by one or more processors, such as processor 610, cause the one or more processors to execute methods described herein.

Software 650, which can be stored in storage 640 and executed by processor 610, can include, for example, the programming that embodies the functionality of the present disclosure (e.g., as embodied in the systems, computers, servers, and/or devices as described above). In one or more examples, software 650 can include a combination of servers such as application servers and database servers.

Software 650 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 640, that can contain or store programming for use by or in connection with an instruction execution system, apparatus, or device.

Software 650 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 600 can implement any operating system suitable for operating on the network. Software 650 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. An autonomous control system of a vehicle, the autonomous control system comprising:
a first sensor to detect a left lane line and a right lane line of a traffic lane when the vehicle is traveling along the traffic lane;
a second sensor to detect an object located within or proximate to the traffic lane; and
one or more computer-readable media storing instructions that, when executed by one or more processors, cause the system to:
process first image data captured by the first sensor to determine locations of the left lane line and the right lane line of the traffic lane;
generate a first control signal based on the determined locations of the left lane line and the right lane line, wherein the first control signal causes the vehicle to follow a vehicle trajectory between the left lane line and the right lane line;
process second data captured by the second sensor to determine an object location and compute an object trajectory; and
generate a second control signal based on at least one of the object location and the object trajectory, wherein the second control signal causes the vehicle to modify at least one of the vehicle trajectory or a vehicle velocity.

2. The control system of claim 1, wherein following the vehicle trajectory between the left lane line and the right lane line comprises controlling one or more vehicle control systems selected from the following: a steering control system, an acceleration control system, and a braking control system.

3. The control system of claim 1, wherein modifying the vehicle velocity comprises controlling one or more vehicle control systems selected from the following: a steering control system, an acceleration control system, and a braking control system.

4. The control system of claim 1, wherein modifying the vehicle trajectory comprises controlling one or more vehicle control systems selected from the following: a steering control system, an acceleration control system, and a braking control system.

5. The control system of claim 1, wherein the instructions cause the system to compute a tolerance zone extending from one or both sides of the vehicle trajectory.

6. The control system of claim 5, wherein the width of the tolerance zone is less than or equal to the width between the left lane line and the right lane line.

7. The control system of claim 5, wherein following the vehicle trajectory comprises remaining within the tolerance zone extending from the vehicle trajectory.

8. The control system of claim 1, wherein computing the object trajectory comprises computing a confidence metric associated with the object trajectory.

9. The control system of claim 8, wherein generation of the second control signal is based on determining the confidence metric associated with the object trajectory meets a confidence threshold.

10. The control system of claim 1, wherein generation of the second control signal is based on a proximity between the object trajectory and at least one of the left lane line or the right lane line.

11. The control system of claim 1, wherein generation of the second control signal is based on a proximity between the object and at least one of the left lane line or the right lane line.

12. The control system of claim 5, wherein generation of the second control signal is based on a proximity between the object trajectory and the tolerance zone.

13. The control system of claim 5, wherein generation of the second control signal is based on a proximity between the object and the tolerance zone.

14. The control system of claim 1, wherein generation of the second control signal is based on a proximity between the object trajectory and at least one of the vehicle or the vehicle trajectory.

15. The control system of claim 1, wherein generation of the second control signal is based on a proximity between the object and at least one of the vehicle or the vehicle trajectory.

16. The control system of claim 1, wherein generation of the second control signal is based on determining that a computed distance between the vehicle and the object is less than a distance threshold.

17. The control system of claim 1, wherein generation of the second control signal is based on a proximity between the object and a blind-spot region located adjacent to the vehicle.

18. The control system of claim 1, wherein modifying at least one of the vehicle velocity or the vehicle trajectory comprises:
increasing a distance between the vehicle and the object; and
maintaining the vehicle trajectory between the left lane line and the right lane line.

19. The control system of claim 18, wherein the instructions cause the system to increase the distance by an amount that delays an intersection between the object trajectory and the vehicle trajectory.

20. The control system of claim 1, wherein the instructions cause the system to generate at least one of an audible driver alert or a visual driver alert.

21. The control system of claim 1, wherein computing the object trajectory comprises tracking the object as it passes from a field of view of the first sensor to a field of view of the second sensor.

22. The control system of claim 1, wherein computing the object trajectory comprises tracking the object as it passes from a field of view of the second sensor to a field of view of the first sensor.

23. The control system of claim 1, wherein the vehicle is a first vehicle and the object is a second vehicle.

24. The control system of claim 1, wherein the second sensor is an optical sensor.

25. The control system of claim 1, wherein the second sensor is a LiDAR sensor.

26. The control system of claim 1, wherein the second sensor is a radar sensor.

27. The control system of claim 1, wherein the second sensor is a sonar sensor.

28. A method for autonomously controlling a vehicle, the method comprising:
processing first image data captured by a first sensor to determine locations of a left lane line and a right lane line of a traffic lane;
generating a first control signal based on the determined locations of the left lane line and the right lane line, wherein the first control signal causes the vehicle to follow a vehicle trajectory between the left lane line and the right lane line;
processing second data captured by a second sensor to determine an object location and compute an object trajectory; and
generating a second control signal based on at least one of the object location and the object trajectory, wherein the second control signal causes the vehicle to modify at least one of the vehicle trajectory or a vehicle velocity.

29. A non-transitory computer readable storage medium storing instructions for autonomously controlling a vehicle, wherein the instructions, when executed by one or more processors of an electronic device, cause the device to:
process first image data captured by a first sensor to determine locations of a left lane line and a right lane line of a traffic lane;
generate a first control signal based on the determined locations of the left lane line and the right lane line, wherein the first control signal causes a vehicle to follow a vehicle trajectory between the left lane line and the right lane line;
process second data captured by a second sensor to determine an object location and compute an object trajectory; and
generate a second control signal based on at least one of the object location and the object trajectory, wherein the second control signal causes the vehicle to modify at least one of the vehicle trajectory or a vehicle velocity.
